(19) United States
(12) Patent Application Publication
(10) Pub. No.: US 2025/0338792 A1
(43) Pub. Date: Nov. 6, 2025

(54) SYSTEM FOR REMOTELY ACCESSING A MOWER AND/OR A DISPLAY THEREOF

(71) Applicant: Textron Inc., Providence, RI (US)

(72) Inventor: Brian David Wanta, North Augusta, SC (US)

(73) Assignee: Textron Inc., Providence, RI (US)

(21) Appl. No.: 18/667,788

(22) Filed: May 17, 2024

Related U.S. Application Data
(60) Provisional application No. 63/642,627, filed on May 3, 2024.

(51) Int. Cl. A01D 34/00; A01D 101/00; G06F 3/14

(52) U.S. Cl. CPC A01D 34/008; A01D 2101/00; G06F 3/1454

(57) ABSTRACT

A mower system includes a mower. The mower includes a chassis, a driveline coupled to the chassis and configured to drive a tractive element to propel the mower, a mowing assembly, an on-board display, and a control system. The control system is configured to acquire a plurality of signals regarding operation of the mower, generate an on-board graphical user interface (GUI) on the on-board display based on the plurality of signals, and transmit the plurality of signals to a remote system. The mower system also includes a non-transitory computer readable medium having instructions stored thereon that, upon execution by the remote system, cause the remote system to receive the plurality of signals from the mower, and generate a remote GUI for display on a remote display based on the plurality of signals to emulate the on-board GUI.

### CROSS-REFERENCE TO RELATED PATENT APPLICATIONS

This application claims the benefit of and priority to U.S. Provisional Patent Application No. 63/642,627, filed May 3, 2024, which is incorporated herein by reference in its entirety.

### BACKGROUND

Mowers are used to maintain vegetation (e.g., grass, clover, weeds, etc.) at a desired height. To accomplish this, mowers include at least one cutting unit having a cutting element that is driven by a motor and a driveline that facilitates navigation of the mower throughout an operating area. Mowers typically include operator controls that permit adjustment of a cutting speed of the cutting unit, a cutting height of the cutting unit, and/or a path followed by the mower (e.g., steering). When issues (e.g., faults, breakdowns, etc.) arise, the mower either needs to be brought to a maintenance location or a technician needs to travel to the mower to diagnose the issue and take corrective actions. However, particularly in remote areas, it can be cumbersome for technicians to diagnose the mower in person.

### SUMMARY

One embodiment relates to a mower system. The mower system includes a mower. The mower includes a chassis, a driveline coupled to the chassis and configured to drive a tractive element to propel the mower, a mowing assembly, an on-board display, and a control system. The control system is configured to acquire a plurality of signals regarding operation of the mower, generate an on-board graphical user interface (GUI) on the on-board display based on the plurality of signals, and transmit the plurality of signals to a remote system. The mower system also includes a non-transitory computer readable medium having instructions stored thereon that, upon execution by the remote system, cause the remote system to receive the plurality of signals from the mower, and generate a remote GUI for display on a remote display based on the plurality of signals to emulate the on-board GUI.

Another embodiment relates to a mower system. The mower system includes a non-transitory computer readable medium having instructions stored thereon that, upon execution by a remote system, cause a remote system to acquire a plurality of controller area network (CAN) signals from a mower and generate a remote graphical user interface (GUI) for display on a remote display based on the plurality of CAN signals to emulate an on-board GUI displayed by an on-board display of the mower without the remote system having access to the on-board display.

Still another embodiment relates to a mower system. The mower system includes a non-transitory computer readable medium having instructions stored thereon that, upon execution by a remote system, cause the remote system to acquire a plurality of controller area network (CAN) signals from a mower; generate a remote graphical user interface (GUI) for display on a remote display based on the plurality of CAN signals to emulate an on-board GUI displayed by an on-board display of the mower without the remote system having access to the on-board display, receive a first input from a remote user of the remote system, update the remote GUI based on the first input without a corresponding update being performed with the on-board GUI on the on-board display, receive a second input from the remote user, and provide a command to the mower based on the second input, the command configured to cause one or more components of the mower to perform a physical function.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a is schematic block diagram of a site monitoring and control system including a plurality of the vehicles of FIG. 1, according to an exemplary embodiment.

FIG. 4 is a schematic diagram illustrating remote access of the vehicle of FIG. 1 in a first mode, according to an exemplary embodiment.

FIG. 5 is a block diagram of a method for remotely accessing the vehicle in the first mode of FIG. 4, according to an exemplary embodiment.

FIG. 6 is a schematic diagram illustrating remote access of the vehicle of FIG. 1 in a second mode, according to an exemplary embodiment.

FIG. 7 is a block diagram of a method for remotely accessing the vehicle in the second mode of FIG. 6, according to an exemplary embodiment.

FIG. 8 is a schematic diagram illustrating remote access of the vehicle of FIG. 1 in a third mode, according to an exemplary embodiment.

FIG. 9 is a block diagram of a method for remotely accessing the vehicle in the third mode of FIG. 8, according to an exemplary embodiment.

FIG. 10 is a schematic diagram illustrating remote access of the vehicle of FIG. 1 in a fourth mode, according to an exemplary embodiment.

FIG. 11 is a schematic diagram illustrating remote access of the vehicle of FIG. 1 in a fourth mode, according to another exemplary embodiment.

FIG. 12 is a block diagram of a method for remotely accessing the vehicle in the fourth mode of FIGS. 10 and 11, according to an exemplary embodiment.

FIGS. 13-15 show various graphical user interfaces generated by a remote system in communication with the vehicle of FIG. 1, according to various exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

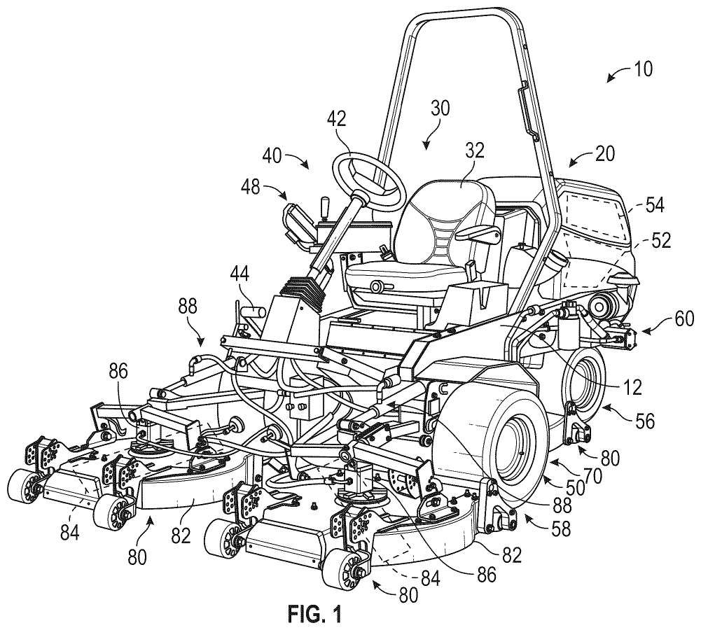

As shown in FIGS. 1-3, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; a series of implements, mower assemblies, or cutting units, shown as mower decks 80; one or more sensors, shown as sensors 90; and a vehicle control system, shown as vehicle controller 100, coupled to the operator controls 40, the driveline 50, the suspension system 60, the braking system 70, the mower decks 80, and the sensors 90. In other embodiments, the vehicle 10 includes more or fewer components.

According to an exemplary embodiment, the vehicle 10 is an off-road machine or vehicle. As shown in FIG. 1, the vehicle 10 is configured as a mower (e.g., a lawnmower, a turf mower, a push mower, a ride-on mower, a stand-on mower, or another type of mower). In other embodiments, the off-road machine or vehicle is a lightweight or recreational machine or vehicle such as a golf cart, golf cars, an all-terrain vehicle (“ATV”), a utility task vehicle (“UTV”), and/or another type of lightweight or recreational machine or vehicle. In some embodiments, the off-road machine or vehicle is a chore product such as aerator, turf sprayer, bunker rake, and/or another type of chore product (e.g., that may be used on a golf course).

According to the exemplary embodiment shown in FIG. 1, the occupant seating area 30 includes a single seat, shown as driver seat 32. In some embodiments, the occupant seating area 30 includes additional seats (e.g., a passenger seat, an additional row of seats, etc.). According to the exemplary embodiment shown in FIG. 1, the driver seat 32 is laterally centered on the body 20 and facing forward. In some embodiments, the driver seat 32 is facing rearward or otherwise positioned. In some embodiments, the occupant seating area 30 is omitted (e.g., the vehicle 10 is configured as a push mower). A portion of the frame 12 defines a platform, deck, or standing area, shown as operator platform 34. The operator platform 34 may extend forward of the driver seat 32 such that the occupant can rest their feet on the operator platform 34 while seated in the driver seat 32. The operator platform 34 may support the occupant as the occupant enters or exits the driver seat 32.

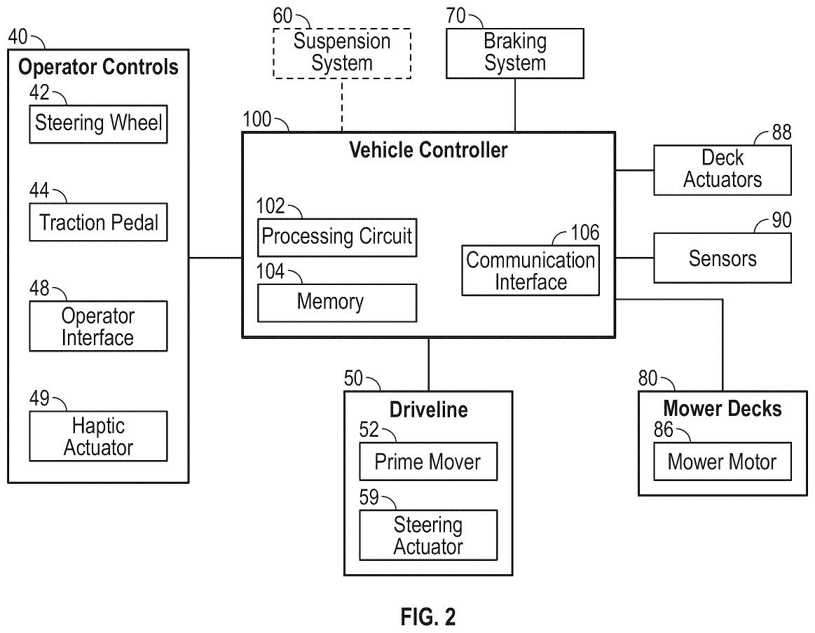

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower a mower deck 80, etc.). As shown in FIGS. 1 and 2, the operator controls 40 include a steering interface (e.g., a steering wheel, joystick(s), etc.), shown steering wheel 42, an accelerator interface and/or braking interface (e.g., a pedal, a throttle, etc.), shown as traction pedal 44, and one or more additional interfaces, shown as operator interface 48. The steering wheel 42 may be used by an operator to indicate a desired steering direction of the vehicle 10. The traction pedal 44 may be used to control the speed and direction of travel of the vehicle 10. By way of example, pressing the traction pedal 44 in a first direction may cause the driveline 50 to move the vehicle 10 forward, and pressing the traction pedal 44 in an opposing section direction may cause the driveline 50 to move the vehicle 10 rearward. Returning the traction pedal 44 to a middle or neutral position may cause the braking system 70 and/or the driveline 50 to slow or stop the vehicle 10 or to hold the vehicle 10 in place. Alternatively, the operator interface 48 may include a pair of handles that act as a steering interface and control the driveline 50 in a zero-turn configuration (e.g., a left joystick to control the left side of the driveline 50 and a right joystick to control a right side of the driveline 50). The operator interface 48 may be used to control operation of the mower decks 80 (e.g., changing a cutting speed of a mower deck 80, changing a cutting height of a mower deck 80, etc.). The operator interface 48 may include one or more displays and one or more input devices. The one or more displays may be or include a touchscreen, an LCD display, a LED display, a speedometer, gauges, warning lights, etc. The one or more input device may be or include buttons, switches, knobs, levers, dials, etc.

In some embodiments, the operator controls 40 include one or more haptic feedback devices (e.g., motors, vibrators, etc.), shown as haptic actuator 49. The haptic actuator 49 provides haptic feedback (e.g., vibration, force, resistance to movement of a component of the vehicle 10, etc.). By way of example, the haptic actuator 49 may vibrate a component contacted by the operator (e.g., the driver seat 32, the steering wheel 42, etc.) to indicate information an operator. By way of another example, the haptic actuator 49 apply a force to a component of the operator controls 40 to communicate information to the operator and/or directly control operation of the vehicle 10. In one such example, the haptic actuator 49 resists rotation of the steering wheel 42 to encourage the operator to steer in a given direction. In another such example, the haptic actuator 49 move the steering wheel 72 to a desired position corresponding to a desired steering heading or steering direction.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is one or more electric motors and the energy storage 54 is a battery system. In some embodiments, the driveline 50 is a fuel cell electric driveline whereby the prime mover 52 is one or more electric motors and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks. In some embodiments, the driveline 50 is omitted, and the vehicle 10 is propelled by an operator (e.g., the vehicle 10 is configured as a push mower).

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., based on an input from the steering wheel 42 and using a steering actuator 59 that controls the orientation of one or more wheels). In some embodiments, both the rear tractive assembly 56 and the front tractive assembly 58 are fixed and not steerable (e.g., employ skid steer operations). By way of example, the driveline 50 may include a hydrostatic transmission that permits independent driving of the left and right sides of the driveline 50.

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, the driveline 50 is a hydrostatic transmission that performs braking by using hydraulic motors to oppose movement of the tractive elements.

Referring to FIG. 1, the vehicle 10 includes a series of mower decks 80 (e.g., cutting units). Each mower deck 80 includes a deck, housing, or enclosure, shown as housing 82, and a cutting element 84 (e.g., a blade, a flail, a reel, etc.) movably coupled to the housing 82. The housing 82 may open downward to expose the cutting element 84 to vegetation below the housing 82. A motor or actuator (e.g., an electric motor, a hydraulic motor, etc.), shown as mower motor 86, is coupled to the housing 82 and drives movement (e.g., rotation, oscillation, etc.) of the cutting element 84. While driven by the mower motor 86, the cutting element 84 crushes, mulches, removes, or otherwise trims vegetation beneath the housing 82. Alternatively, the cutting element 84 may be driven by the prime mover 52 (e.g., through a power take off).

The vehicle 10 includes a series of linear actuators or height adjustment actuators, shown as deck actuators 88, each coupled to the frame 12 and to one or more of the mower decks 80. The deck actuators 88 permit control over a height of the corresponding mower deck 80 relative to the frame 12. The deck actuators 88 may set a cutting height of the mower deck 80. The cutting height represents a final height of vegetation that is trimmed by the mower deck 80. The deck actuators 88 may move the mower deck 80 to a travel position above the cutting height, in which the mower deck 80 is moved out of engagement with the vegetation and the ground surface. The travel position may be used when the vehicle 10 is traveling between job sites and/or the user does not wish to be trimming vegetation.

The sensors 90 may include various sensors positioned about the vehicle 10 to acquire vehicle information or vehicle data regarding operation of the vehicle 10, or the location thereof. The sensors 90 may include various sensors positioned about the vehicle 10 to acquire environment data regarding the environment surrounding the vehicle 10. By way of example, the sensors 90 may include an accelerometer, a gyroscope, a compass, a position sensor (e.g., a GPS sensor, an RTK sensor, etc.), an inertial measurement unit (“IMU”), suspension sensor(s), wheel sensors, an audio sensor or microphone, a camera, an optical sensor, a proximity detection sensor, linear potentiometers, and/or other sensors to facilitate acquiring vehicle information, vehicle data, or environment data regarding operation of the vehicle 10, the location thereof, and/or the surrounding environment. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

As shown in FIG. 2, the vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communication interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communication interface 106, a controller area network (“CAN”) bus, etc.). According to an exemplary embodiment, the vehicle controller 100 is coupled to (e.g., communicably coupled to) components of the operator controls 40 (e.g., the steering wheel 42, the traction pedal 44, the brake 46, the operator interface 48, etc.), components of the driveline 50 (e.g., the prime mover 52), components of the braking system 70, the mower decks 80, the deck actuators 88, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communication interface 106 as described in greater detail herein).

The communication interface 106 facilitate communications (e.g., wired or wireless communications) between the vehicle 10 and other devices (e.g., other vehicles 10, the user sensors 220, a user portal 230, the remote systems 240, etc.). By way of example, the communications interface 130 may be configured to employ one or more types of wireless communications protocols including Bluetooth, Wi-Fi, radio, cellular, and/or other suitable wireless communications protocols.

### Site Monitoring and Control System

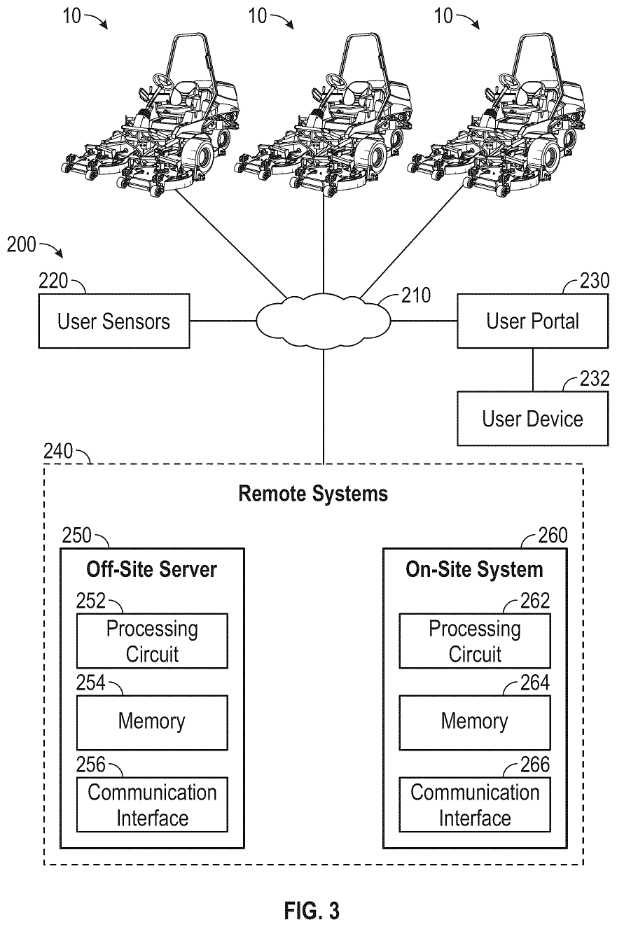

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210 (e.g., using the communication interface 106).

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc.; location; movement; etc.) regarding the operator. The user sensors 220 may communicate directly with the vehicles 10, directly with the remote systems 240, and/or indirectly with the remote systems 240 (e.g., through the vehicles 10 as an intermediary). For example, the user sensors 220 may facilitate determining a position of the user (e.g., operator, drier, etc.) by providing a signal to the remote systems 240 and user portal 230.

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like, shown as user device 232. The user portal 230 and the user device 232 communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement. According to some embodiments, the remote system 240 may only send commands to the vehicle 10 if the user sensors 220 are detected near the vehicle 10. For example, the display emulator system may be configured to determine that a user is seated in the driver seat 32 (e.g., determined by a seat sensor, etc.) prior to the remote system 240 providing the command.

In some embodiments, the command is an action, such as lowering the mower deck 80 or adjusting the driveline 50, that can only be performed in response to determining that the user is present (e.g., seated in the driver seat 32, etc.).

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Remote Access

According to an exemplary embodiment, the site monitoring and control system 200, including the vehicle controller 100, the user sensors 220, the user portal 230, the user device 232, and the remote systems 240 (which may be referred to herein as a “remote access system” or a “display emulator system”), is configured to facilitate remotely accessing the vehicles 10 or data/signals thereon and generating a remote GUI that emulates an on-board GUI displayed via the operator interface 48. Generally, as described in greater detail herein, the vehicle controller 100 is configured to generate an on-board graphical user interface (GUI) based on a plurality of vehicle signals regarding operation of the vehicle 10 and the remote system 240 is configured to remotely access or acquire the vehicle signals to generate a remote GUI emulating the on-board GUI.

### First Remote Access Mode

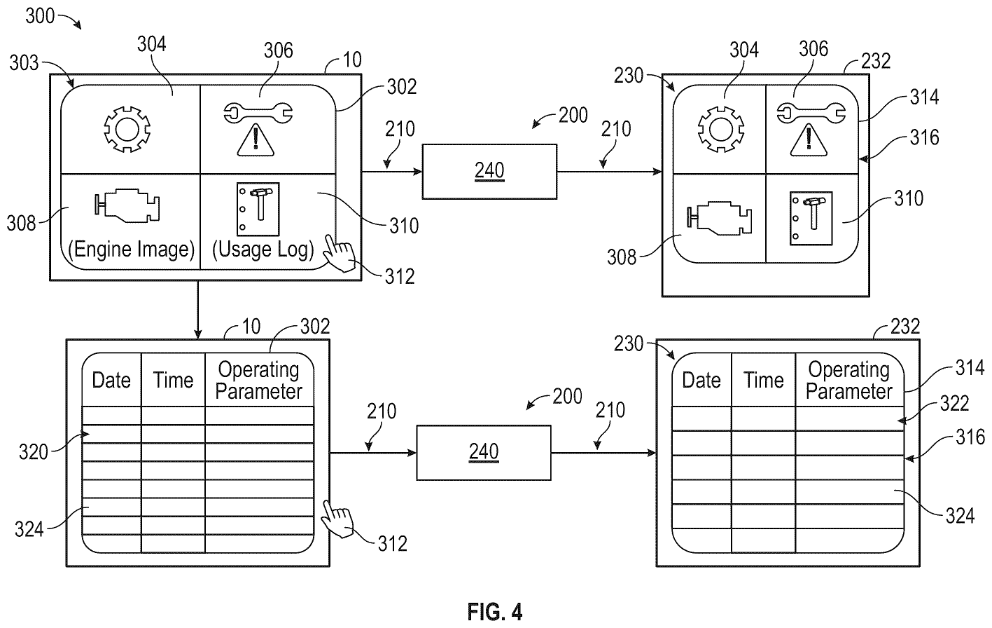

As shown in FIG. 4, the remote access system is operable in a first mode (e.g., a mirror mode, an emulator mode, etc.), shown as first remote access mode 300. The operator interface 48 of the vehicle 10 includes a first display device (e.g., an on-board device including a display), shown as on-board display 302. The on-board display 302 is communicably coupled to the vehicle controller 100 via a CAN bus. The on-board display 302 is any type of screen capable of displaying a GUI. In some embodiments, the on-board display is a touch screen display configured to receive a touch input from the user. The operator interface 48 of the vehicle 10 or the vehicle 10 may further include a speaker and/or microphone configured to provide audio and receive an audio input (e.g., which may be transmitted to or from the remote system 240, the user device 232, etc.).

As previously described, the vehicle controller 100 is configured to acquire (e.g., via the communication interface 106, etc.) a plurality of vehicle signals regarding operation of the vehicle 10 (e.g., CAN signals). In some embodiments, the vehicle controller 100 receives one or more vehicle signals from the sensors 90. By way of example, the sensors 90 may include one or more accelerometers, one or more gyroscopes, an IMU within a controller of the prime mover 52 (e.g., a motor controller of a motor), an IMU within a GPS device installed on the vehicle 10, temperature sensors, current sensors, battery sensors, visual sensors (e.g., cameras), and/or other sensors disclosed herein. In some embodiments, data from multiple of the same type of sensor is used to improve data quality or otherwise enhance the data's predictive value. In some embodiments, the vehicle controller 100 additionally or alternatively receives the plurality of vehicle signals from components of one of the suspension system 60, the braking system 70, the deck actuators 88, the mower decks 80 (e.g., the mower motor 86), the operator controls 40, but is not limited thereto. The plurality of vehicle signals may indicate an error or issue that arose during operation of the vehicle 10 or an issue regarding a component of the vehicle 10. For example, the vehicle signals may indicate an abnormal operating parameter, such as a parameter outside of a preset range, or indicate an error communicating with a component of the vehicle 10.

As shown in FIG. 4, the vehicle controller 100 (e.g., a vehicle control system, a mower control system, etc.) is configured to generate (e.g., via the processing circuit 102, via instructions stored on the memory 104, etc.) a first on-board GUI, shown as on-board GUI 303, on the on-board display 302 based on the plurality of vehicle signals. The on-board GUI 303 may include a plurality of elements (e.g., options, virtual buttons, etc.) or icons. As shown in FIG. 4, the icons include, but are not limited to, a control setting icon 304, an issue identifier icon 306, an engine setting icon 308, and a usage log icon 310. The on-board display 302 is configured to display on-board GUIs including the on-board GUI 303 generated by the vehicle controller 100. The vehicle controller 100 is also configured to receive (e.g., via the communication interface 106, etc.) an input from an operator via the on-board display 302. For example, an operator 312 of the vehicle 10 may select (e.g., by touch, or use of a selection device such as a button, etc.) an icon (e.g., the icon 304, the icon 306, the icon 308, the icon 310, etc.) from the on-board GUI 303 displayed on the on-board display 302.

As shown in FIG. 4, the vehicle controller 100 is configured to connect to the remote system 240 over the communications network 210 and the user device 232 is configured to connect to the user portal 230 through the remote system 240 over the communications network 210. More specifically, the vehicle controller 100 is configured to transmit vehicle signals (e.g., CAN signals) to the remote system 240 over the communications network 210 and the user device 232 is configured to access the user portal 230 through the remote system 240 to access the vehicle signals from the vehicle 10 or information generated at the remote system 240 based on the vehicle signals. In some embodiments, the plurality of signals are stored (e.g., saved, etc.) in the remote system 240, such as in the memory 254 of the off-site server 250 or the memory 264 of the on-site system 260, such that a virtual model of the vehicle 10 (e.g., a virtual vehicle, a virtual machine, etc.) is stored and accessible at any time regardless of an operating status (e.g., on, off, in standby, etc.) of the vehicle 10. In some embodiments, the plurality of signals are real-time signals that are not stored for an extended period of time (e.g., for longer than a communications session between the vehicle 10 and the user device 232).

As shown in FIG. 4, the user device 232 includes a second display device (e.g., a computer display, a screen, a touch screen, etc.), shown as remote display 314. In some embodiments, the user device 232 includes a speaker and/or a microphone. The speaker may be configured to provide audio outputs based on communications with the vehicle 10 and/or the remote system 240. The microphone may be configured to receive an audio input for providing an input to (e.g., for communicating with, etc.) the vehicle 10 and/or the remote system 240.

According to an exemplary embodiment, the remote system 240 is configured to generate (e.g., via the processing circuit 252, etc.) a remote GUI for display on the remote display 314 based on the plurality of vehicle signals to emulate (e.g., mirror, etc.) the on-board GUI 303. As shown in FIG. 4, the remote system 240 is configured to receive the plurality of vehicle signals and independently generate (e.g., create, form, etc.) a first remote GUI, shown as remote GUI 316, corresponding to (e.g., mirroring, emulating, copying, etc.) the on-board GUI 303 (e.g., without accessing the on-board GUI 303, the on-board display 302, or the operator interface 48).

The remote system 240 is configured to generate and updates the remote GUI 316 to emulate the on-board GUI 303 without actually accessing the on-board GUI 303 such that (a) when a selection (e.g., an input, etc.) is made by the operator 312 of the vehicle 10 on the on-board display 302 or the operator interface 48 or (b) the operator 312 performs some function with the vehicle 10 (e.g., a mow function, a drive function, a mode selection function, etc.) that impacts the on-board GUI 303 being displayed on the on-board display 302, the vehicle signals corresponding thereto are sent to the remote system 240, and the remote system 240 is configured to independently and in real-time update the remote GUI 316 on the remote display 314 based on the updated vehicle signals to emulate the on-board GUI 303 as changes occur. For example, as shown in FIG. 4, the operator 312 selects the usage log icon 310. In response to the operator 312 providing the selection of the usage log icon 310 (e.g., a touch input, a clicking the icon, etc.), the on-board display 302 is configured to generate a second on-board GUI, shown as on-board GUI 320. Simultaneously, or at about the same time, the remote system 240 generates a second remote GUI, shown as remote GUI 322, for display on the remote display 314 that emulates the on-board GUI 320. According to the exemplary embodiment shown in FIG. 4, the on-board GUI 320 displays a plurality of data, shown as vehicle information 324, regarding operations, error messages, etc. that occurred during operation of the vehicle 10.

In implementation, the operator 312 of the vehicle 10 may contact a remote user (e.g., a remote operator, a technology expert, a technician, etc.) when an issue arises (e.g., using the operator interface 48, with a phone, with a computer, etc.). The remote user may then access the user portal 230 via the user device 232 to remotely evaluate the vehicle signals or information related to the vehicle 10 in real-time without having to be present at the vehicle 10. The remote system 240 may then be configured to acquire the vehicle signals from the vehicle 10 and independently generate a remote GUI on the remote display 314 to emulate the on-board GUI so that the remote user can see the same thing that the operator 312 is seeing on the on-board display 302 (e.g., to facilitate remote evaluation, diagnostics, etc.). Therefore, the remote user may then be more capable of remotely diagnosing the issue and can instruct the operator 312 on mitigating actions or fixes to rectify the issue or to temporarily rectify the issue until a technician can make it on site to the vehicle 10.

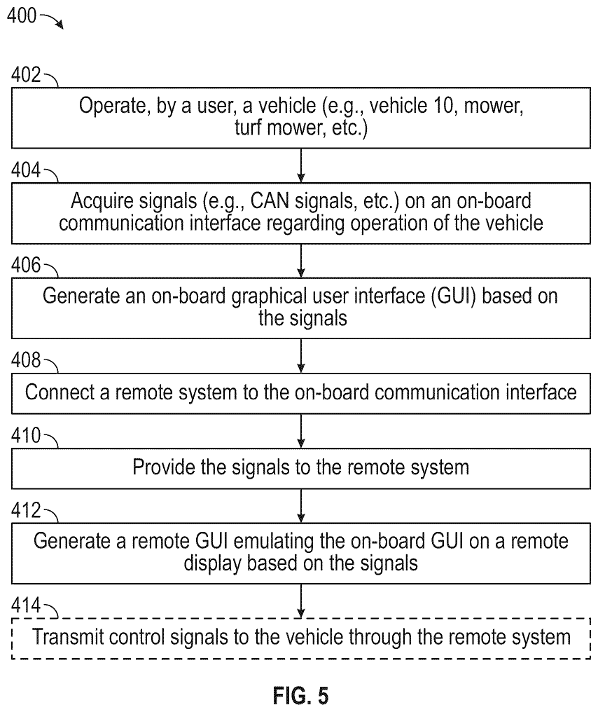

Now referring to FIG. 5, a method 400 for remotely accessing a vehicle (e.g., the vehicle 10) in the first remote access mode 300 is shown, according to an exemplary embodiment. As shown in FIG. 5, the method 400 begins with a local user (e.g., the operator 312, etc.) operating the vehicle at step 402. According to this embodiment, the vehicle is a mower operated by the user to cut grass.

During operation of the vehicle and/or after operating the vehicle (e.g., the vehicle 10 is stopped, etc.), vehicle signals, such as CAN signals, are acquired regarding operation of the vehicle at step 404. For example, a communication interface (e.g., the communication interface 106, etc.) of the vehicle may acquire the signals. A vehicle controller (e.g., the vehicle controller 100) is then configured to generate an on-board GUI (e.g., the on-board GUI 303, the onboard GUI 320, etc.) based on the vehicle signals at step 406. The on-board GUI may include selectable features and may provide further information and/or data corresponding to the vehicle signals in response to being selected (e.g., clicked on, tapped, etc.).

At step 408, a remote system (e.g., the remote system 240, the user device 232, etc.) is configured to connect to the on-board communication interface of the vehicle via a network (e.g., the communications network 210). In some embodiments, the remote system is in continuous connection with or periodically connects to the vehicle. In some embodiments, the remote system is only in communication with the vehicle when a remote user attempts to access the vehicle with a remote user device (e.g., the user device 232). At step 410, the vehicle signals are provided from the on-board communication interface of the vehicle to the remote system. For example, the vehicle signals are transmitted from the on-board communication interface through the communications network to the remote system. According to some embodiments, as the vehicle signals are transmitted through the communications network, the vehicle signals are also saved in a memory (e.g., the memory 254) of the remote system such that a virtual vehicle is created (e.g., in a cloud storage, in a remote storage, etc.) for viewing/access regardless of the operating state of the vehicle. For example, a user, such as a remote user, may access data and information regarding operating parameters of the vehicle while the vehicle is off by accessing the virtual vehicle stored in the remote system.

At step 412, after receiving the vehicle signals, the remote system is configured to generate a remote GUI emulating the on-board GUI on a remote display (e.g., the remote display 314 of the user device 232 through the user portal 230) based on the vehicle signals. Accordingly, even though the on-board GUI and the remote GUI are independently generated, because the on-board GUI and the remote GUI are based on the same vehicle signals the remote GUI emulates/mirrors or substantially emulates/mirrors the on-board GUI. Accordingly, because the remote user can see the same thing (e.g., the same GUI) as the local user, the remote user may be better able to remotely diagnose the vehicle and provide instructions to the local user without having to be on site.

In some embodiments, the remote user can provide inputs via the remote user device to transmit control signals to the vehicle (e.g., to adjust a setting, a cause the vehicle to perform some function to help with the diagnostics process, to play a voice message, to adjust a display, to display instructions, etc.). At step 414, the remote system transmits control signals (e.g., inputs, control inputs, commands, instructions, etc.) based on such inputs. For example, the remote user may provide (e.g., input, etc.) a control signal or a command to the remote system 240 (e.g., via the remote display 314, the user device 232, etc.) and the remote system may be configured to transmit (e.g., provide, send, etc.) the control signal or the command to the communication interface of the vehicle for implementation by the vehicle controller. The vehicle controller may then implement the received control signal or command. In some embodiments, the remote user provides instructions (e.g., typed, video, verbal instructions, etc.) and the operator may implement the instructions themselves. For example, the instructions may be provided through the on-board display and include step-by step instructions, for example, for fixing a mechanical issue or how to adjust a parameter or setting of the vehicle. In some embodiments, the remote user can input instructions to the remote system using the remote user device (e.g., by selecting an input on the remote GUI, etc.), and the input may be transmitted to the communication interface of the vehicle for implementation by the vehicle controller (e.g., automatically, etc.) such that the vehicle performs some action associated with the input of the remote user. For example, the action may include, adjusting an operating parameter or an operator setting such as adjusting (e.g., lowering, raising, etc.) the mower deck height, controlling the prime mover, steering the vehicle, etc. In response to the vehicle performing the action, the remote system may be configured to acquire the vehicle signals regarding operation of the vehicle.

### Second Remote Access Mode

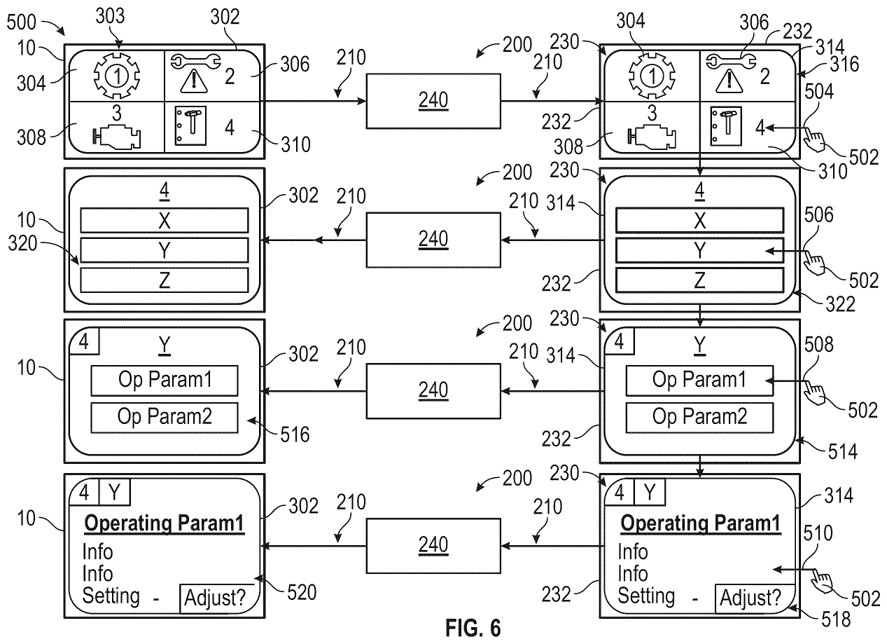

As shown in FIG. 6, the remote access system is operable in a second mode (e.g., a remote control mode), shown as second remote access mode 500. Similar to the first remote access mode 300, in the second remote access mode 500, the vehicle controller 100 is configured to receive a plurality of vehicle signals and generate on-board GUIs based on the vehicle signals. For example, the vehicle controller 100 generates the on-board GUI 303 based on the plurality of vehicle signals and then connects to the remote system 240 and provides the remote system 240 the plurality of vehicle signals. The remote system 240 is then configured to generate the remote GUI 316 on the remote display 314 emulating the on-board GUI 303 similar to the first remote access mode 300.

However, as shown in FIG. 6, the remote system 240 is configured to receive one or more inputs (e.g., a touch input, a selection, etc.) from a remote user 502 (e.g., a remote operator, etc.). For example, the input may be a selection of an icon and/or virtual button of the remote GUI 316 displayed on the remote display 314. As shown in FIG. 6, in response to receiving inputs, shown as inputs 504, 506, 508, and 510, from the remote user 502, the remote system 240 is configured to generate updated remote GUIs 322, 514, and 518 through the user portal 230 and display the updated remote GUIs 322, 514, and 518, respectively, on the remote display 314 of the user device 232. The remote system 240 is further configured to provide (e.g., transmit, etc.) the inputs 504, 506, 508, and 510 to the vehicle 10. The vehicle controller 100 is configured to update the on-board GUI 303 to provide updated on-board GUIs 320, 516, and 520 based on the inputs 504, 506, 508, and 510 to emulate the remote GUIs as they are updated by the remote user 502. The vehicle controller 100 is also configured to implement any actions associated with the inputs 504, 506, 508, and 510 (e.g., adjusting the display, adjusting a component or setting of the vehicle 10, etc.) as if such inputs were entered into the operator interface 48 by the operator 312. Accordingly, during the second remote access mode 500, the remote user 502 can control the remote GUIs of the remote display 314 and the on-board display 302 will emulate the remote GUIs and the vehicle controller 100 will implement any changes entered through the remote GUIs to the vehicle 10. By way of example, if the inputs adjust the current remote GUI, the vehicle controller 100 will similarly adjust the on-board GUI. By way of another example, if the inputs adjust a setting or parameter of a component, the vehicle controller will display such adjustments on the on-board GUI and implement the adjustments to the component as they occur remotely. By way of yet another example, if the inputs related to a command for a component of the vehicle 10 to perform some action (e.g., drive, turn on, raise, lower, spin, etc.), the vehicle controller 100 will control the component of the vehicle 10 to perform such action. After such processes by the remote user 502, the first remote access mode 300 may be re-initiated so that the remote user 502 can inspect the impacts of such remote control. In some embodiments (e.g., if the inputs cause the vehicle 10 to physically move), the second remote access mode 500 is only accessible by the remote user 502 when the operator 312 is preset with or proximate the vehicle 10 (e.g., as detected by a seat sensor, by other detection methods, etc. to prevent operation of the vehicle 10 without anyone present locally).

After providing inputs (e.g., the first input 504, the fourth input 510, etc.), the user device 232 is configured to disconnect from the vehicle 10. After disconnecting, the vehicle controller 100 may remain connected to the remote system 240 such that the vehicle controller 100 can continue to provide data (e.g., operational data, operating parameters, etc.) to the remote system 240. In such instances, the user device 232 may be able to selectively connect to the vehicle controller 100 and/or the remote system 240 to access information regarding the vehicle 10 in real-time or after the fact. For example, a remote user (e.g., the remote user 502, etc.) may access a virtual vehicle model of the vehicle 10 stored in the remote system 240 at any time to view operating parameters or information regarding the operation of the vehicle 10.

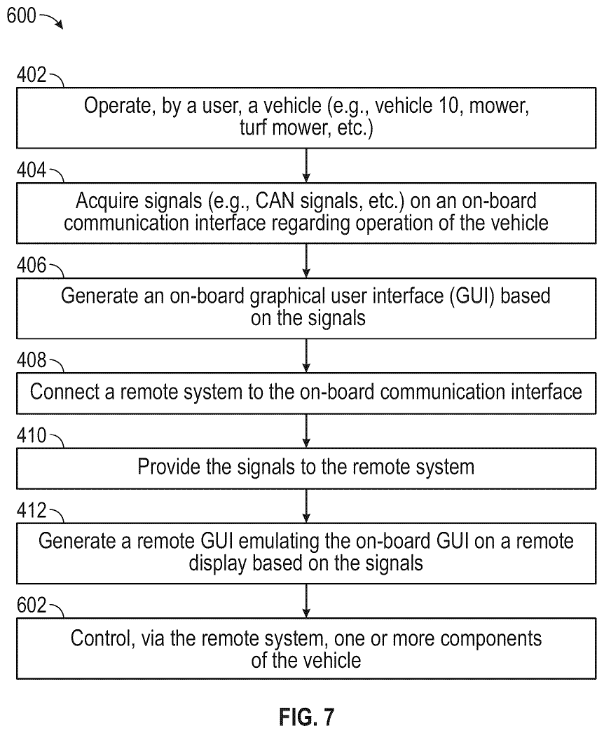

Now referring to the FIG. 7, a method 600 for remotely accessing a vehicle (e.g., the vehicle 10) in the second remote access mode 500 is shown, according to an exemplary embodiment. Similar to the method 400, the method 600 includes steps 402-412. However, the method 600 further includes step 602. At step 602, a remote user (e.g., the remote user 502, etc.) controls, via the remote system (e.g., the user device 232, the user portal 230, the remote system 240, etc.), one or more components of the vehicle 10. For example, the remote user may provide an input to the remote server that includes a command to (a) update the display, (b) adjust or move a component (e.g., such as raising or lowering the mower deck 80, driving the vehicle 10, steering the vehicle 10, etc.), and/or (c) adjust an operational setting. The remote server may then transmit the command to the vehicle, and the vehicle controller may then implement the command.

### Third Remote Access Mode

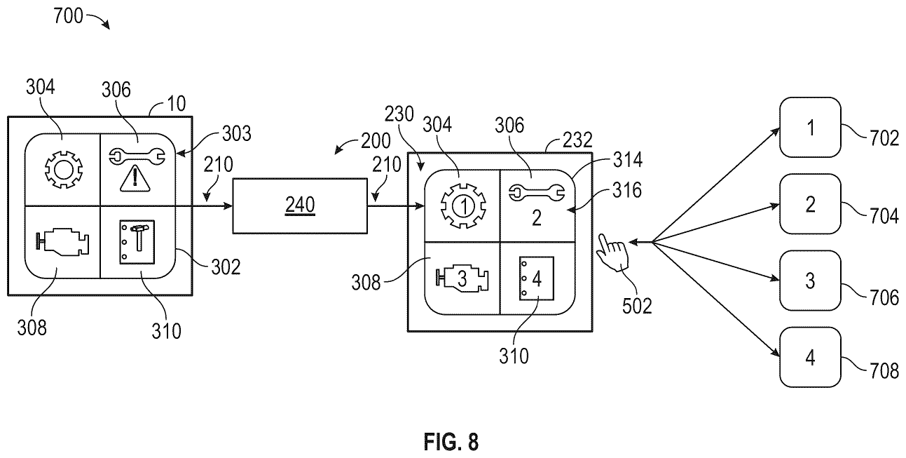

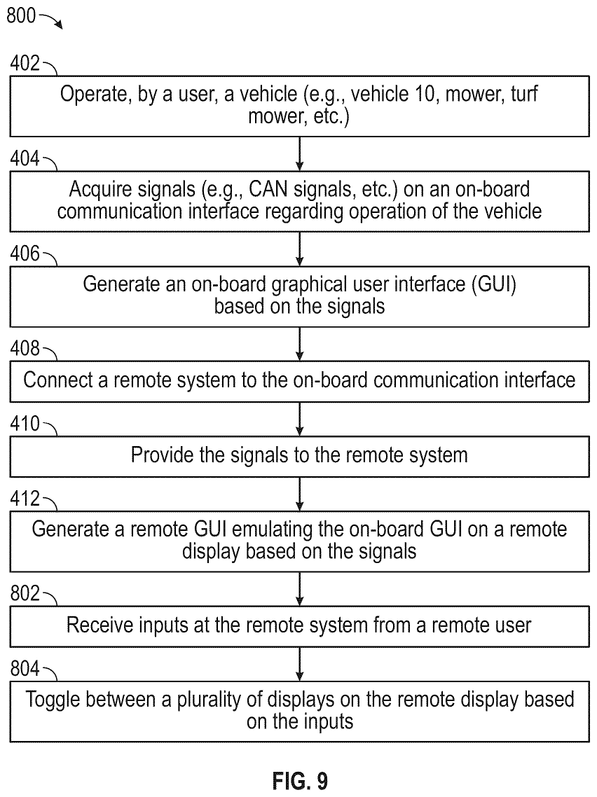

As shown in FIG. 8, the remote access system is operable in a third mode (e.g., a behind-the-scenes mode), shown as third remote access mode 700. Similar to the first remote access mode 300 and the second remote access mode 500, in the third remote access mode 700, the vehicle controller 100 is configured to receive a plurality of vehicle signals and generate on-board GUIs based on the vehicle signals. For example, the vehicle controller 100 generates the on-board GUI 303 based on the plurality of vehicle signals and then connects to the remote system 240 and provides the remote system 240 the plurality of vehicle signals. The remote system 240 is then configured to generate the remote GUI 316 on the remote display 314 emulating the on-board GUI 303 similar to the first remote access mode 300 and the second remote access mode 500.

From the remote GUI 316, the remote system 240 is configured to receive an input from the remote user 502. For example, the remote user 502 can select (e.g., click, tap, etc.) a portion of the remote GUI 316 (e.g., icons 304, 306, 308, 310, etc.). In response to receiving the input from the remote user 502, the remote system 240 is configured to generate a second remote GUI (e.g., update the remote GUI 316, GUI 702, GUI 704, GUI 706, GUI 708, etc.) based on the input without a corresponding update being performed on the on-board GUI (e.g., the on-board GUI 303) currently being displayed on the on-board display 302.

For example, as shown in FIG. 8, the remote user 502 may select icon 304. In response to selecting icon 304, the remote system 240 is configured to update the remote GUI 316 or switch to a new remote GUI based on the selection of the icon 304. Similarly for the selection of any of the plurality of icons (e.g., icon 306, icon 308, icon 310, etc.), the remote system 240 is configured to update the on-board GUI displayed on the remote display 314 accordingly. According to this embodiment, the remote user 502 may select a first icon (e.g., icon 304, etc.) causing the remote system 240 to generate an updated remote GUI (e.g., a remote GUI 702, etc.) and then return back (e.g., select a return button, select a back option, etc.) to the original remote GUI (e.g., the remote GUI 316, etc.) without a corresponding update being performed on the on-board GUI 303 of the on-board display 302. The remote user 502 may then select a second icon (e.g., icon 306, etc.) causing the remote system 240 to generate an updated remote GUI (e.g., a remote GUI 704, etc.), and then return to the original remote GUI (e.g., the remote GUI 316, etc.) without a corresponding update being performed on the on-board GUI 303 of the on-board display 302. For example, the on-board display 302 may continue to display the on-board GUI 303 generated by the vehicle controller 100 based on the plurality of vehicle signals, while the remote user 502 switches between various remote GUIs.

According to this embodiment, the remote user 502 may toggle (e.g., switch, etc.) between a plurality of remote GUIs, such as the remote GUI 316, the remote GUI 702, the remote GUI 704, the remote GUI 706, the remote GUI 708, etc., or update the remote GUI 316, etc., without a corresponding update being performed (e.g., by the vehicle controller 100) on the on-board GUI 303 displayed on the on-board display 302. Accordingly, the remote user 502 can operate in the background or behind the scenes and inspect the vehicle 10 and/or adjust parameters without impacting the on-board display 302.

Now referring to the FIG. 8, a method 800 for remotely accessing a vehicle (e.g., the vehicle 10) in the third remote access mode 700 is shown, according to an exemplary embodiment. Similar to the method 400 and the method 600, the method 800 includes the steps 402-412. The method 800 further includes steps 802 and 804. At step 802, the remote system receives inputs from a remote user (e.g., the remote user 502) via a user device (e.g., the user device 232). Then, at step 804, the remote system toggles (e.g., switches, etc.) between a plurality of displays, or remote GUIs, on a remote display (e.g., the remote display 314) based on the inputs without impacting the on-board GUI.

### Fourth Remote Access Mode

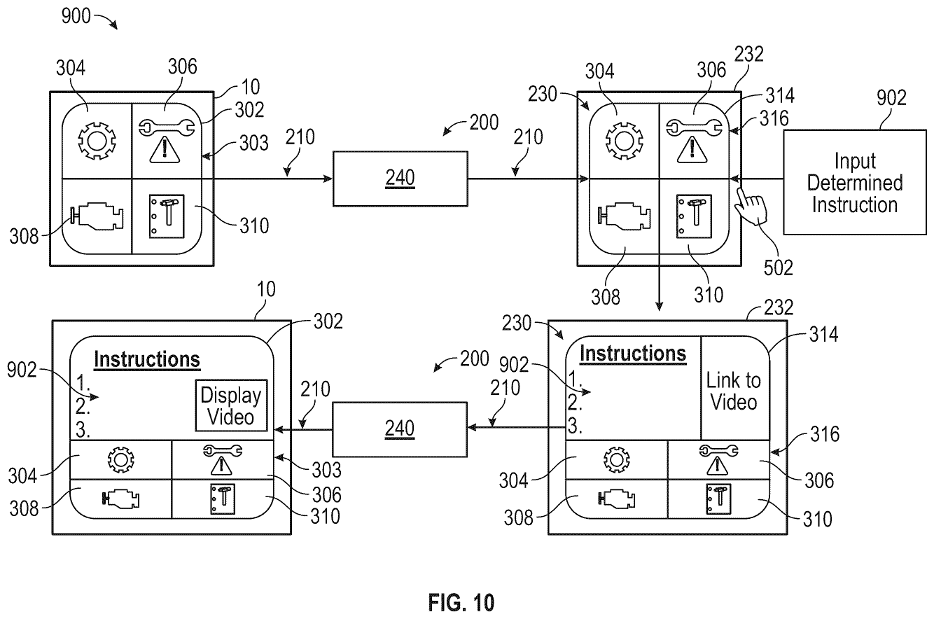

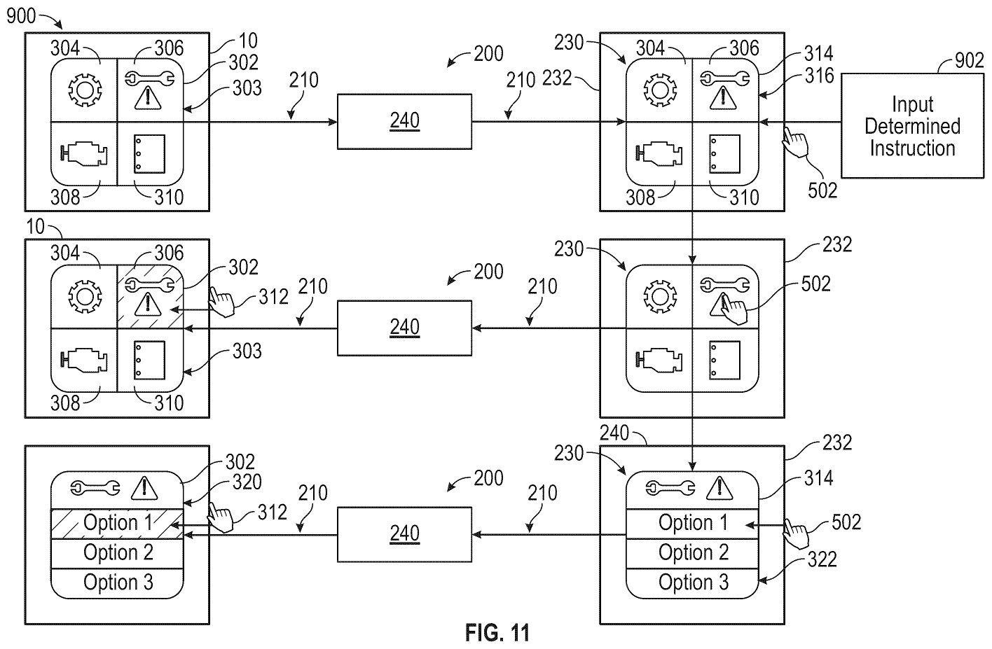

As shown in FIGS. 10 and 11, the remote access system is operable in a fourth mode (e.g., an instruction mode), shown as fourth remote access mode 900. Similar to the first remote access mode 300, the second remote access mode 500, and the third remote access mode 700, in the fourth remote access mode 900, the vehicle controller 100 is configured to receive a plurality of vehicle signals and generate on-board GUIs based on the vehicle signals. For example, the vehicle controller 100 generates the on-board GUI 303 based on the plurality of vehicle signals and then connects to the remote system 240 and provides the remote system 240 the plurality of vehicle signals. The remote system 240 is then configured to generate the remote GUI 316 on the remote display 314 emulating the on-board GUI 303 similar to the first remote access mode 300, the second remote access mode 500, and the third remote access mode 700.

As shown in FIGS. 10 and 11, the remote system 240 is configured to receive an input from the remote user 502 via the user device 232. More specifically, the input includes instructions 902. In some embodiments, the instructions 902 include step-by-step includes, a voice message, a live chat, pictures, and/or videos. For example, the remote user 502 may input the instructions 902 via a keyboard, a microphone, etc. using the user device 232, which is provided to the remote system 240. The remote system 240 is configured to transmit the instructions 902 to the vehicle controller 100. The vehicle controller 100 is configured to update the on-board GUI 303 displaying the instructions 902 on-board display 302.

As shown in FIG. 10, step-by-step instructions and a video link are entered into the user device 232 and transmitted to the vehicle 10 for display on the on-board display 302. The operator 312 can then review the instructions and watch a video to help trouble shoot any issues that they are having with the vehicle 10. As shown in FIG. 11, the instructions 902 include a series of inputs entered by the remote user 502 on the remote display 314. The series of inputs are recorded and then transmitted to the vehicle controller 100 by the remote system 240. The vehicle controller 100 is then configured to update the on-board GUI 303 in response to the series of inputs, such that the operator of the vehicle 10 is prompted to select (e.g., touch, tap, click, etc.) highlighted portion of the on-board GUI 303 corresponding to the series of inputs entered by the remote user 502.

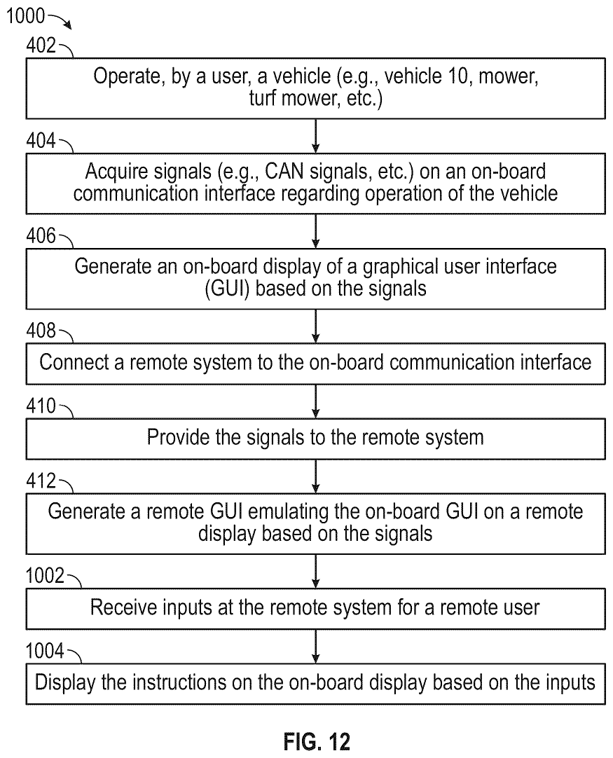

Now referring to the FIG. 12, a method 1000 for remotely accessing a vehicle (e.g., the vehicle 10) in fourth remote access mode 900 is shown, according to an exemplary embodiment. Similar to the method 400, the method 600, and the method 800, the method 1000 includes the steps 402-412. The method 1000 further includes steps 1002 and 1004.

At step 1002, the remote system receives inputs from a remote user (e.g., the remote user 502, etc.) via a user device (e.g., the user device 232). According to this embodiment, the inputs are instructions. The instructions can include one or more of, but are not limited to, step-by-step written instructions, verbal instructions, videos, and highlights of the on-board GUI.

Then at step 1004, the instructions are displayed on the on-board display of the vehicle based on the inputs provided by the remote user. For example, the instructions are transmitted from the remote system to the communication interface of the vehicle controller. The vehicle controller is configured to generate or update the on-board GUI including the instructions provided by the remote user.

### Exemplary GUIs

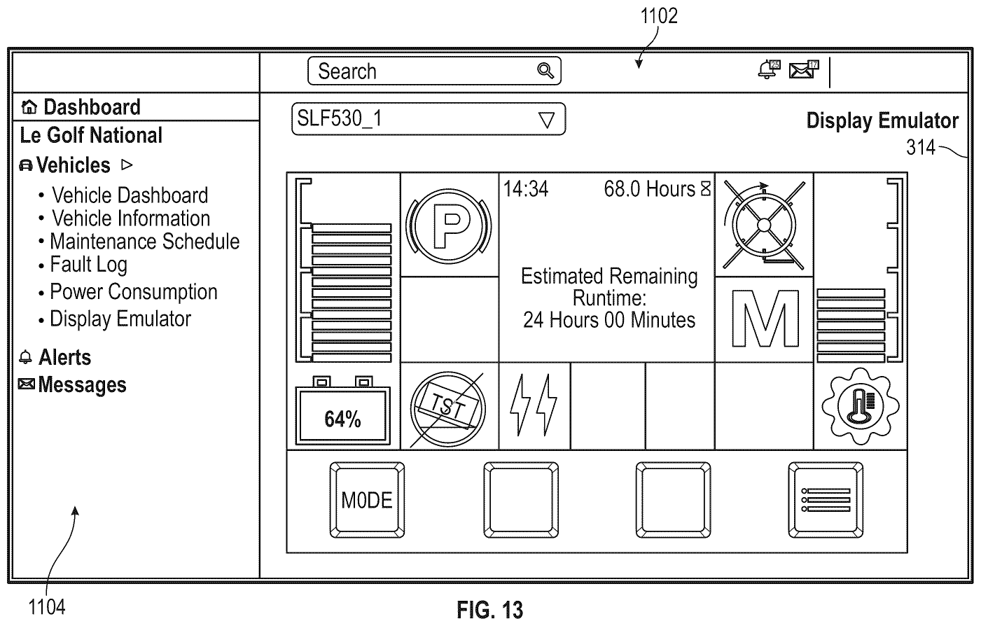

As shown in FIGS. 13-15, various remote GUIs are shown, according to various embodiments. Referring generally to FIGS. 13-15, remote GUIs 1102, 1202, and 1302 are examples of the remote GUI 316 provided on the remote display 314 of the user device 232. The remote GUIs 1102, 1202, and 1302 includes a dashboard 1104. According to this embodiment, the dashboard 1104 is positioned on the left side of the remote GUIs 1102, 1202, and 1302. In other embodiments, the dashboard 1104 maybe positioned elsewhere on the remote GUIs 1102, 1202, and 1302 or be selectively hidden from view on the remote GUIs 1102, 1202, and 1302.

From the dashboard 1104, the remote user 502 can toggle (e.g., select, switch, etc.) between information regarding a plurality of the vehicles 10. For example, the remote user 502 may toggle between connecting to a plurality of the vehicles 10 currently in use via the communications network 210. In some embodiments, the remote user 502 may toggle between viewing a plurality of virtual vehicles corresponding to each vehicle 10 regardless of the operating status of each vehicle 10.

From the dashboard 1104, the user can select a plurality of options or modes (e.g., to generate a new remote GUI, to generate a second remote GUI, etc.) including, but not limited to, a vehicle dashboard, vehicle information, maintenance schedule, fault log, power consumption, or display emulator. The display emulator option prompts the user device 232 to generate a remote GUI emulating the on-board GUI as described in modes 300, 500, 700, 900.

As shown in FIGS. 13-15, the remote GUIs 1102, 1202, and 1302 illustrate exemplary remote GUIs generated to emulate the on-board GUI of the on-board display 302. As shown in FIG. 13, the remote GUI 1102 includes various icons (e.g., images, illustrations, visuals, etc.) based on vehicle signals received by the communication interface 106. According to some embodiments, the icons may be selectable icons configured to cause the remote system 240 to update the remote GUI. As shown in FIG. 13, the remote GUI 1102 of FIG. 13 includes icons and text corresponding to, but not limited to, an estimated remaining run time, a battery level, a parking status, a vehicle temperature (e.g., of an engine, a motor, a battery, etc.), a vehicle mode, a charging status, a motor operating parameter or setting (e.g., cut speed, drive speed, etc.), etc.

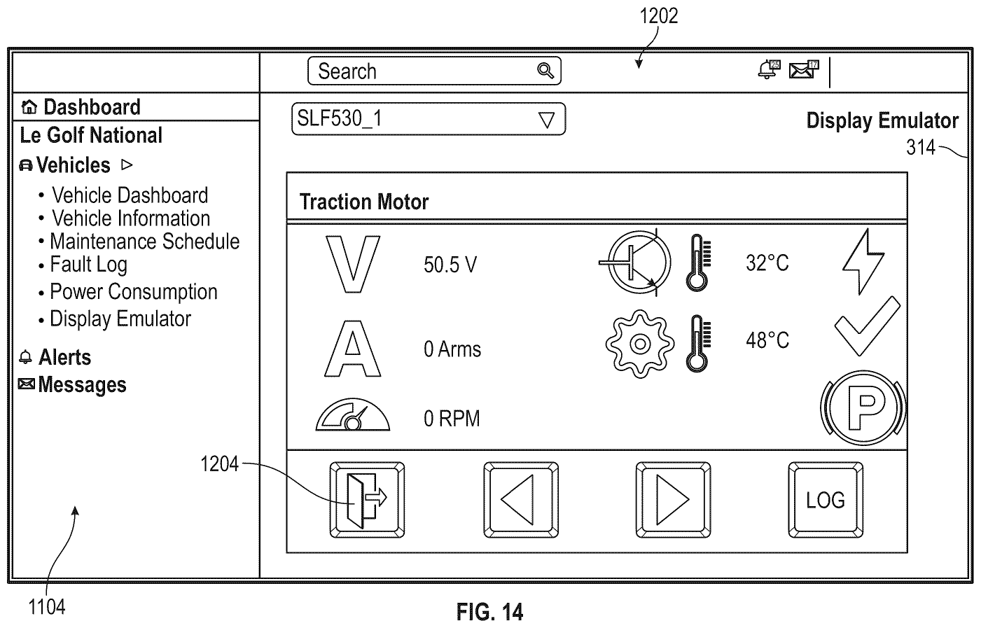

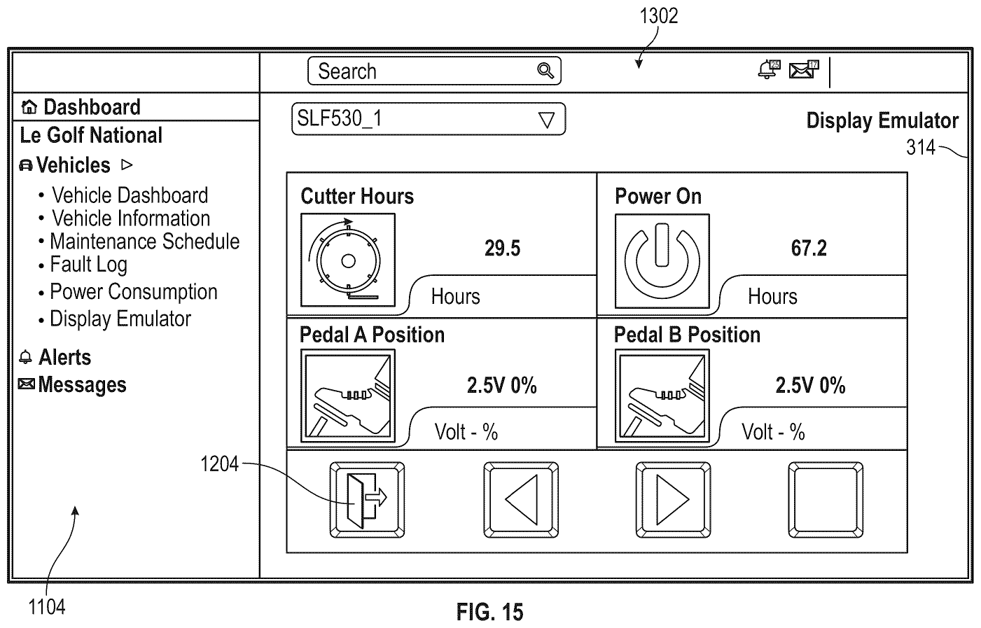

As shown in FIG. 14, the remote GUI 1202 is generated in response to an input from the operator 312 at the vehicle 10 and the corresponding vehicle signals generated in response. For example, the remote GUI 1202 may be generated in response to the operator 312 selecting a “traction motor” icon on the on-board display 302, and the remote system 240 receiving vehicle signals associated with the selection of the “traction motor” icon (e.g., the mirror mode). In other embodiments, the remote GUI 1202 is generated in response to inputs from the remote user 502 via the user device 232 (e.g., in the behind-the-scenes mode, in the remote control mode, etc.). The remote GUI 1202 includes visuals or graphical elements corresponding to a voltage, a current, a speed (“RPM”), a temperature, and/or other operating characteristics or settings corresponding to the traction motor (e.g., the prime mover 52). Further, the remote GUI 1202 includes a return option 1204 that causes the remote system 240 to (a) generate a previous first remote GUI, for example, the remote GUI 1102 shown in FIG. 12 or (b) exit the display emulator functionality. As shown in FIG. 15, the remote GUI 1302 illustrates a plurality of information regarding the operation of the vehicle 10, including but not limited to, cutter hours, run time/power on, a pedal A position, and a pedal B position. According to an exemplary embodiment, the user device 232 is configured such that the user can toggle between a plurality of remote GUIs for a respective vehicle (e.g., during the behind-the-scenes mode, during the remote control mode, etc.) or a plurality of vehicles. For example, the user may toggle back and forth between any of remote GUIs 1102, 1202, and 1302 for a specific vehicle or for a plurality of vehicles.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the vehicle controller 100, etc.) as shown in the various exemplary embodiments is illustrative only. Additionally, any element disclosed in one embodiment may be incorporated or utilized with any other embodiment disclosed herein. By way of example, a vehicle controller 100 may utilize both precision mowing and adaptive mowing.

1. A mower system comprising:
a mower including:
a chassis;
a driveline coupled to the chassis and configured to drive a tractive element to propel the mower;
a mowing assembly;
an on-board display; and
a control system configured to:
acquire a plurality of signals regarding operation of the mower;
generate an on-board graphical user interface (GUI) on the on-board display based on the plurality of signals; and
transmit the plurality of signals to a remote system; and
a non-transitory computer readable medium having instructions stored thereon that, upon execution by the remote system, cause the remote system to:
receive the plurality of signals from the mower; and
generate a remote GUI for display on a remote display based on the plurality of signals to emulate the on-board GUI.

2. The mower system of claim 1, wherein:
the instructions cause the remote system to:
receive an input from a remote user of the remote system; and
transmit the input to the mower;
the control system is configured to:
receive the input from the remote system; and
implement an action associated with the input.

3. The mower system of claim 2, wherein the input includes a chat message, and wherein the action includes displaying the chat message on the on-board display.

4. The mower system of claim 2, wherein the input includes a voice message, and wherein the action includes playing the voice message through a speaker of the mower.

5. The mower system of claim 2, wherein the input includes instructions to address an issue indicated by the plurality of signals, and wherein the action includes displaying the instructions on the on-board display.

6. The mower system of claim 5, wherein the instructions include at least one of a video or step-by-step instructions with pictures.

7. The mower system of claim 2, wherein the input includes a command for one or more components of the mower, and wherein the action includes providing the command to the one or more components of the mower.

8. The mower system of claim 7, wherein the one or more components include at least one of the driveline, the mowing assembly, or the on-board display.

9. The mower system of claim 8, wherein the one or more components include the on-board display.

10. The mower system of claim 8, wherein the command includes at least one of raising or lowering a mower deck of the mowing assembly, controlling a speed of the driveline, or steering the driveline.

11. The mower system of claim 10, wherein in response to implementing the action, the remote system is configured to collect data regarding operation of the mower.

12. The mower system of claim 10, wherein an on-site user must be present for the control system to implement the action, and wherein the mower includes a sensor configured to determine a presence of the on-site user.

13. The mower system of claim 1, wherein the instructions cause the remote system to:
receive an input from a remote user of the remote system; and
update the remote GUI based on the input without a corresponding update being performed with the on-board GUI on the on-board display.

14. The mower system of claim 13, wherein:
the input is a first input;
the instructions cause the remote system to receive a second input from the remote user;
each of the first input and the second input includes a command for one or more components of the mower.

15. The mower system of claim 14, wherein the first input causes a physical change with the mower, and the second input causes a parameter or setting change with the mower.

16. The mower system of claim 1, wherein the plurality of signals are controller area network (CAN) signals.

17. A mower system comprising:
a non-transitory computer readable medium having instructions stored thereon that, upon execution by a remote system, cause the remote system to:
acquire a plurality of controller area network (CAN) signals from a mower; and
generate a remote graphical user interface (GUI) for display on a remote display based on the plurality of CAN signals to emulate an on-board GUI displayed by an on-board display of the mower without the remote system having access to the on-board display.

18. The mower system of claim 17, wherein the instructions cause the remote system to at least one of:
(a) receive a first input from a remote user of the remote system and update the remote GUI based on the first input without a corresponding update being performed with the on-board GUI on the on-board display; or
(b) receive a second input from the remote user and provide a command to the mower based on the second input, the command configured to cause one or more components of the mower to perform a physical function, the one or more components including a driveline or a mowing assembly of the mower.

19. The mower system of claim 17, further comprising the mower.

20. A mower system comprising:
a non-transitory computer readable medium having instructions stored thereon that, upon execution by a remote system, cause the remote system to:
acquire a plurality of controller area network (CAN) signals from a mower;
generate a remote graphical user interface (GUI) for display on a remote display based on the plurality of CAN signals to emulate an on-board GUI displayed by an on-board display of the mower without the remote system having access to the on-board display;
receive a first input from a remote user of the remote system;
update the remote GUI based on the first input without a corresponding update being performed with the on-board GUI on the on-board display;
receive a second input from the remote user; and
provide a command to the mower based on the second input, the command configured to cause one or more components of the mower to perform a physical function.
